(19) United States
(12) Patent Application Publication
(10) Pub. No.: US 2025/0137531 A1
(43) Pub. Date: May 1, 2025

(54) Electromagnet and Locking Arrangement With Electromagnet and Spring-pretensioned Latching Means

(71) Applicant: SVM Schultz Verwaltungs-GmbH & Co. KG, Memmingen (DE)

(72) Inventors: Robin Gruber, Benningen (DE); Ralph Wassermann, Holzgünz (DE)

(21) Appl. No.: 18/926,623

(22) Filed: Oct. 25, 2024

(30) Foreign Application Priority Data
Oct. 26, 2023 (DE) 102023129608.6

(51) Int. Cl. F16H 63/34

(52) U.S. Cl. CPC F16H 63/3475; F16H 63/3433; F16H 2312/12

(57) ABSTRACT

A locking arrangement has an electromagnet having an armature and an armature rod, a component which is rotatable about an axis in a first direction of rotation and in an opposite second direction of rotation and has circumferential engagements, a latching means with a restoring surface, which is connected to the armature rod and is adjustable between a latching position and a release position, a spring element which pretensions the latching means into the latching position and allows the latching means to be restored into the release position. The rotatable component can act on the restoring surface during rotation in the second direction of rotation to bring the latching means into the release position counter to the spring force of the spring element.

### CROSS-REFERENCE TO RELATED APPLICATIONS

This non-provisional application claims the benefit of, and priority to, German Application No. 102023129608.6, entitled Actuating Unit for an Electromagnet and Locking Arrangement With Electromagnet and Spring-Pretensioned Latching Means, filed on Oct. 26, 2023, which is incorporated by reference in its entirety.

### FIELD OF THE DISCLOSURE

The present disclosure generally relates to an electromagnet for a locking arrangement, and locking arrangements containing the electromagnet.

### BACKGROUND

From practice, in particular from the technical field of parking locks and parking brakes, locks of rotatable shafts on the basis of a bistable solenoid, for example in a hand brake, are known. An armature rod of the solenoid serves to block the rotation of the shaft. Such a construction is problematic especially with regard to the large installation space requirement.

However, the scope of functions of known locks is also in need of improvement in view of the necessity of a temperature-induced readjustment function, in particular for electromotive parking locks and parking brakes. This is because a hot-driven electromotive parking brake is usually pretensioned with an electric motor when the vehicle is switched off. By latching of the motor shaft to the magnet of the electromotive parking lock, the parking brake effect is achieved—the brake can no longer turn “on”. However, when the brake is cooled, the component dimensions decrease and the parking locks are released, as a result of which the vehicle can move.

For this purpose, a systemic solution is proposed in practice, in which the electric motor is re-rotated after a few minutes on the basis of an electronically stored cooling curve of the brake and the brake linings are again applied more firmly to the disc/drum. However, previously known locking arrangements are not sufficiently reliable and durable to permit such a readjustment function. In addition, a permanent electromagnetic holding force of previously known locking arrangements prevents reliable readjustment. This is because, for a readjustment, the armature has to be moved from its locking or blocking position. During this time, the system is “open” and does not prevent a motor vehicle from rolling away in the event of a malfunction. The renewed production of the locked or blocked position takes too long and/or cannot be realized reliably in the event of a malfunction.

### SUMMARY

Disclosed is an electromagnet for a locking arrangement, the electromagnet including: an armature, which can be fixed in at least one stable and permanent-magnetic end position; an armature rod; a selectively energizable coil for adjusting the armature; and a spring element which is supported at one end on a first bearing base and at another end on a second bearing base, which is mounted movably relative to the first bearing base; wherein the second bearing base is movable relative to the armature, the armature rod, or both the armature and the armature rod i) while the selectively energizable coil is not energized, ii) during a stable and permanent-magnetic end position of the armature, or iii) both i) and ii).

Disclose is a locking arrangement including: an electromagnet having an armature and an armature rod; a component which is rotatable about an axis in a first direction of rotation and in an opposite second direction of rotation, wherein the component has circumferential engagements; a latching means having a restoring surface, wherein the latching means is connected to the armature rod and is adjustable between a latching position and a release position, wherein in the latching position the latching means engages in one of the circumferential engagements for preventing rotation in the first direction of rotation of the component, wherein in the release position, the latching means comes out of engagement with the one of the circumferential engagements to release rotation in the opposite second direction of rotation of the component; and a spring element that pretensions the latching means into the latching position and allows the latching means to be restored into the release position, wherein the component can act on the restoring surface of the latching means during rotation in the opposite second direction of rotation in order to bring the latching means into the release position that is counter to a spring force of the spring element.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 shows a schematic view of an electromagnet;

FIG. 2 shows a first longitudinal sectional view of a locking arrangement of a first embodiment;

FIG. 3 shows a second longitudinal sectional view of the locking arrangement of the first embodiment;

FIG. 4 shows a third longitudinal sectional view of the locking arrangement of the first embodiment;

FIG. 5 shows a first longitudinal sectional view of a locking arrangement of a second embodiment;

FIG. 6 shows a second longitudinal sectional view of the locking arrangement of the second embodiment;

FIG. 7 shows a third longitudinal sectional view of the locking arrangement of the second embodiment;

FIG. 8 shows a first longitudinal sectional view of a locking arrangement of a third embodiment;

FIG. 9 shows a second longitudinal sectional view of the locking arrangement of the third embodiment;

FIG. 10 shows a third longitudinal sectional view of the locking arrangement of the third embodiment; and

FIG. 11 shows a first longitudinal sectional view of a locking arrangement of a fourth embodiment.

### DETAILED DESCRIPTION

In the figures, identical or mutually corresponding elements are denoted in each case by the same reference signs and will therefore not be described anew unless expedient. To avoid repetitions, features that have already been described will not be described again, and such features are applicable to all elements with the same or mutually corresponding reference signs unless this is explicitly ruled out. The disclosures in the description are transferable analogously to identical parts with the same reference signs or the same component designations. It is also the case that the positional indications used in the description, such as for example above/top, below/bottom, lateral, etc., relate to the figure presently being described and illustrated and, in the case of the position being changed, are to be transferred analogously to the new position. Furthermore, it is also possible for individual features or combinations of features from the different exemplary embodiments shown and described to constitute independent or inventive solutions or solutions.

An electromagnet for a locking arrangement is proposed, comprising an armature, which can be fixed in at least one stable and permanent-magnetic end position, an armature rod, a selectively energizable coil for adjusting the armature, a spring element, which is supported at one end on a first bearing base, and is supported at the other end on a second bearing base, which is mounted movably relative to the first bearing base such that the second bearing base is movable relative to the armature and/or the armature rod while the coil is not energized and/or during a stable and permanent-magnetic end position of the armature.

The spring element allows the movability and restoring of the second bearing base while the coil is not energized and/or during a stable and permanent-magnetic end position of the armature. This advantage permits readjustment without, however, having to move the armature by means of an energized coil.

The first bearing base can be realized by the armature, the armature rod, a pawl or a pawl part. The second bearing base can be realized by the armature rod, a component guided on the armature rod, for example a guide housing, a pawl or a pawl part (for example, another pawl part).

The permanent-magnetic holding of the armature can be effected for example by means of the coil or a yoke.

The configurations and advantages described below in the context of the locking arrangement should equally also be considered to be disclosed and able to be claimed in the context of the electromagnet, with this also being intended to apply conversely.

A locking arrangement is also proposed, comprising an electromagnet having an armature and an armature rod, a component which is rotatable about an axis in a first direction of rotation and in an opposite second direction of rotation and has circumferential engagements, a latching means with a restoring surface, which is connected to the armature rod, and is adjustable between a latching position, in which it engages in one of the engagements for preventing rotation in the first direction of rotation of the rotatable component, and a release position, in which it comes out of engagement with the one engagement of the engagements to release rotation in the second direction of rotation of the rotatable component, a spring element, which pretensions the latching means into the latching position and allows the latching means to be restored into the release position, wherein the rotatable component can act on the restoring surface during rotation in the second direction of rotation, in order to bring the latching means into the release position counter to the spring force of the spring element. The electromagnet can be an electromagnet according to the disclosure.

In the latching position, the latching means prevents rotation of the rotatable component in the first direction of rotation and allows rotation of the rotatable component in the second direction of rotation. It is then advantageously possible for the rotatable component to be rotated out of the latching position, in which, for example, the locking arrangement prevents the unintentional rolling away of a motor vehicle, in the second direction of rotation, for example in order to readjust it after a few minutes and to be able to apply brake linings more firmly against a disc/drum again. A readjustment is possible in the release position. The spring element permits the readjustment and also produces the renewed latching position again. Therefore, the readjustment can take place without assistance of the electromagnet or the activation thereof. Owing to the engagements, the readjustment can take place in the manner of a ratchet. This is because the rotatable component can be rotated further in the second direction of rotation in relation to the latching means for as long as desired; the latching means can immediately engage in any engagement and, upon further rotation in the second direction of rotation, can be brought again into the release position.

The circumferential side of the rotatable component can have teeth with tooth flanks which are formed by the circumferential engagements.

The action of the rotatable component on the restoring surface during rotation in the second direction of rotation, in order to bring the latching means into the release position counter to the spring force of the spring element, can take place in the latching position. The action on the restoring surface in order to bring the latching means into its release position can be effected by means of a corresponding engagement or tooth or tooth flank.

The locking arrangement can be adjustable between a driving position and a parking position by means of adjustment of the armature. In the driving position, the latching means can be spaced apart from the rotatable component on the basis of a corresponding adjustment of the armature. The distance can be an air distance. The latching means can be in a neutral position there. In the parking position, the latching means can be in its latching position on the basis of a corresponding adjustment of the armature. In the parking position, the latching means can also be adjustable into its release position, this not being brought about, however, by the adjustment of the armature, but being permitted by the spring element.

The electromagnet can adjust the armature between a deployed extension position and a retracted retraction position. The driving position or the parking position can be provided in the extension position. The respective other of the driving position and the parking position can be provided in the retraction position. The electromagnet can be a bistable solenoid. The extension position and the retraction position can thus be provided in stable end positions of the armature. In these end positions, the armature can be held permanent-magnetically. In aspects, there is no energization to secure the end position. The armature can adjust the armature rod in order to produce the latching position of the latching means. As a result, the latching position (of the latching means) and/or parking position (of the locking arrangement) can be produced in a simple manner.

The locking arrangement therefore permits a movement of the latching means counter to the force of the spring element without having to adjust the armature from its end position and having to bring it back into this end position after the readjustment. Moreover, the release position and also the renewed latching position can be produced without current. Energization and switching of the electromagnet for the purpose of readjustment is avoided. Safety is thus considerably improved, since a situation is avoided in which the locking arrangement is “open” in its parking position because of the energization for the purpose of the readjustment and specifically cannot prevent an undesired rolling away of a motor vehicle.

The spring element can allow the release position because of its own compression or energy absorption. The spring element can produce the latching position because of its own expansion or energy release. It also has a tolerance compensation function. By virtue of the fact that it pretensions the latching means into the latching position, it can compensate for a tolerance between a end position, and in some cases a stable end position, of the armature and an end stop of the latching means in engagement with the rotatable component and ensure a secure latching position.

The locking arrangement may be a parking lock locking arrangement or a parking brake locking arrangement.

In aspects, the restoring surface can be designed and/or arranged in such a way that contacting by the rotatable component and its rotation in the second direction of rotation leads to an adjustment of the latching means. In aspects, the adjustment is a longitudinal adjustment of the latching means in the direction of the axis or in the longitudinal direction.

In aspects, the latching means can have the restoring surface and a latching surface. The surfaces can be arranged on opposite sides of the latching means and/or can face in opposite directions. The latching surface can bear against an engagement of the rotatable component and prevent the rotation of the rotatable component in the first direction of rotation.

In aspects, the latching surface can be designed and/or arranged in such a way that contacting by the rotatable component prevents the rotation of the rotatable component in the first direction of rotation. The contacting with the latching surface can be made by means of a corresponding engagement or tooth.

The armature rod can be hollow and/or can be multi-part. For this purpose, it can comprise at least a first and a second armature rod part. As a result, the mass of the armature rod is reduced for improved adjustability and throughflow capability. The armature rod parts can be plugged into one another and/or fixedly connected to one another. This serves to reduce a required installation space and for optimum functionality. The interiors of the armature rod parts can be directly fluidically connected to one another, for example by means of end-side holes in the armature rod parts. This leads to the best possible throughflow capability over the shortest possible path. An armature rod part can form an outer circumferential flange on its end side, for example, integrally. The outer circumferential flange can define the armature stop. As a result, it is possible to dispense with further components in order to save installation space and to avoid connections. An armature rod part can form a diameter step, for example, integrally. The diameter step can define a direct bearing against which the spring element can be supported. As a result, it is possible to dispense with further components in order to save installation space and to avoid connections.

According to one embodiment of the locking arrangement, for example according to a first aspect, the latching means can be fixedly connected to the armature rod. This reduces the number of components and leads to a uniform movement of armature rod and latching means. The latching means can be fastened on the armature rod, for example, on one end of the rod. This avoids kinematics requiring installation space between armature rod and latching means. The rod end is the end which faces the rotatable component.

In aspects, the latching means can be a latching wedge. The latching wedge can reliably prevent the rotation in the first direction of rotation of the rotatable component in the latching position in a functionally effective but at the same time geometrically simple manner, but can also be brought into the release position. Moreover, the latching surface and the restoring surface can be formed in a geometrically simple manner on both wedge sides.

According to one embodiment of the locking arrangement, the armature can be mounted movably relative to the armature rod. In an advantageous manner, armature and armature rod can move relative to one another. Thus, specifically, even in a stable end position of the armature when the coil of the electromagnet is without current, the armature rod can be adjusted with the latching means counter to the spring force—the release position of the latching means can be realized in a simple manner. However, it may advantageously also apply conversely that the latching-means-induced movement of the armature rod has no influence on the stable end position of the armature—the armature retains its stable position. As a result, a small spring element can be used, since it does not have to work against magnetic forces. The armature can be mounted movably on the armature rod and/or on an armature tube and/or on a coil body and/or on a bearing bushing. In addition, so-called drawer effects between armature and armature rod, which can be caused by magnetic and other transverse forces, can thereby be avoided.

In aspects, the latter can be designed such that the latching means can be brought into the release position counter to the spring force of the spring element and the subsequent movement of the latching means into the latching position can take place while the armature is stationary. Moreover, in the meantime, the armature can remain in a stable position and/or the coil can be unenergized in the meantime. Advantageously, therefore, neither energization is necessary nor does an air gap have to be produced at the armature. The locking arrangement can reliably prevent the unintentional rolling away of a motor vehicle. This can be brought about, for example, by means of the spring element and the relatively movable mounting of armature with respect to armature rod.

According to one embodiment of the locking arrangement, the armature rod can have or form an armature stop, by means of which it can strike against the armature. The armature stop can be configured as an outer circumferential step or diameter step. The armature stop can advantageously be used two-fold. Firstly, it can define an end position between armature and armature rod—the armature rod is then not adjustable further. As a result, an adjustment travel of the armature rod can be restricted. Secondly, the armature stop can act as a driver and can carry along the armature rod when the armature is adjusted. As a result, the latching means can be electromagnetically caused to move out of its latching position. As a result of the armature stop, the armature rod can therefore be restricted in adjustment travel in one of its adjustment directions (for example in the direction of the rotatable component) and can be positively coupled to the armature so as to be movable in the opposite adjustment direction relative to the armature.

In aspects, the armature stop can butt against the armature in the latching position of the latching element and/or in the neutral position of the latching element. The abutment can be caused by the spring element. As a result, a compact design can be realized. In the neutral position, the latching means can be spaced apart from the rotatable component. The distance can be an air distance. The distancing can be effected on the basis of corresponding adjustment of the armature. The armature can be designed for this purpose.

According to one embodiment of the locking arrangement, the spring element can be a helical spring which can be supported at one end on the armature and at the other end directly on the armature rod or on a supporting part fixedly connected to the armature rod. The armature itself can be kept permanent-magnetic, with the result that it is a secure bearing base for the spring element, in particular in its extension position. The support of the spring element on both sides of the armature and armature rod leads to a mechanical coupling of the two parts. The spring element can also be a meandering spring or cup spring. For the direct support, the armature rod can form a diameter step or flange, for example, integrally. This reduces the number of required components.

In aspects, the spring force of the spring element can be lower than a permanent-magnetic holding force of the armature, for example, in its extension position. As a result, the spring element can advantageously not be capable of adjusting the armature, even if the latching means is brought into its release position counter to the spring force and counteracts the permanent-magnetic holding force of the armature.

In aspects, the action of the rotatable component on the restoring surface upon rotation in the second direction of rotation can lead to an adjustment of the latching means and of the armature rod in the direction of the axis. The armature rod can thus be pushed into the housing of the electromagnet.

According to one embodiment of the locking arrangement, for example according to a second aspect, the latching means can be a one-part pawl and/or can be mounted at one end movably relative to the armature rod, for example via an elongate hole, and/or can be mounted rotatably at the other end. The pawl allows a non-linear adjustment of the latching means between latching position and release position. In addition, the location of the latching between latching means and engagement can be situated remotely from the electromagnet or can be provided laterally with respect to the longitudinal axis. The elongate hole permits a controlled and guided movement of the pawl. The one-part pawl can consist of a single piece. The latching means can have a tooth which forms the restoring surface and the latching surface. The latching means can be mounted at the other end on a rotary bearing.

In aspects, armature rod and latching means can be kinematically coupled to one another such that a linear adjustment of the armature rod leads to rotation of the latching means. As a result, the latching means can be pivoted out of its latching position.

According to one embodiment of the locking arrangement, the armature rod can comprise a guide housing which can be movably guided on an armature rod body and can have a bearing point, for example a bearing mandrel, for the latching means. The guide housing can be guided movably in the longitudinal direction on the armature rod body. The armature rod body can be encompassed by the armature rod. The movability between armature rod body and guide housing can be advantageous if the armature is fixedly connected to the armature rod. This is because the adjustment of the latching means into its release position can then be made possible by the adjustment of the guide housing. The latching means can be mounted at the bearing point; the bearing mandrel can engage in the elongate hole. The bearing mandrel can be oriented perpendicular to the longitudinal axis.

According to a conceivable embodiment of the locking arrangement, the inner circumferential side of the guide housing can have a support surface for guiding on the armature rod body. As a result, the guide housing is securely guided and secured against tilting. For reasons of simple and cost-effective production, the inner circumferential supporting surface can be formed by a wall of the guide housing which is turned over inwards radially.

In aspects, the guide housing can be arranged on one end of the armature rod body. This reduces the required installation space.

According to a conceivable embodiment of the locking arrangement, the spring element can be a helical spring which is supported at one end on the guide housing and at the other end directly on the armature rod or the armature rod body or on a supporting part fixedly connected to the armature rod or to the armature rod body or to the armature. As a result, the guide housing, and thus also the latching means connected thereto, can be pretensioned. The armature rod/the armature rod body or the armature each constitute a secure bearing base for the spring element. The support of the spring element on both sides of the armature rod/armature rod body/armature and guide housing leads to a mechanical coupling of the two parts. Such a location of the spring element makes it possible for the guide housing to be adjusted and pretensioned independently of the position of the armature or of the armature rod or of the armature rod body. The spring element can also be a meandering spring or cup spring.

In aspects, the spring element can be arranged on the outer circumferential side with respect to the armature rod or the armature rod body. This arrangement saves on installation space.

In aspects, the spring element can be arranged within the guide housing. This arrangement saves on installation space and protects the spring element from contamination.

In aspects, the armature rod or the armature rod body can have or form a guide housing stop. The guide housing stop can be configured as an outer circumferential step or diameter step. The guide housing stop can advantageously be used two-fold. Firstly, it can define an end position between armature rod/armature rod body and guide housing—the guide housing is then not adjustable further. As a result, an adjustment travel of the guide housing can be restricted. Secondly, the guide housing stop can function as a driver and can carry along the guide housing when armature rod/armature rod body/armature is adjusted. As a result, the latching means can be electromagnetically caused to move out of its latching position. As a result of the guide housing stop, the guide housing can therefore be restricted in adjustment travel in one of its adjustment directions and can be movable in the opposite adjustment direction relative to armature rod and/or armature rod body and/or armature and can be positively coupled to armature rod and/or armature rod body and/or armature.

In aspects, the armature can be fixedly connected to the armature rod or the armature rod body. This reduces the number of components and leads to a uniform movement of armature and armature rod/armature rod body. This avoids movability, requiring installation space, between armature and armature rod/armature rod body.

In aspects, the latter can be designed such that the latching means can be brought into the release position counter to the spring force of the spring element and the subsequent movement of the latching means into the latching position can take place while the armature is stationary. Moreover, in the meantime, the armature can remain in a stable position and/or the coil can be unenergized in the meantime. Advantageously, therefore, neither energization is necessary nor does an air gap have to be produced at the armature. The locking arrangement can reliably prevent the unintentional rolling away of a motor vehicle. This can be brought about, for example, by means of the spring element and the relatively movable mounting of armature or armature rod with respect to the guide housing.

According to one embodiment of the locking arrangement, for example according to a third aspect, the latching means can be a multi-part pawl and/or can be mounted at one end movably relative to the armature rod, for example via an elongate hole, and/or can be mounted rotatably at the other end. The multi-part pawl allows a non-linear adjustment of the latching means between latching position and release position. In addition, the location of the latching between latching means and engagement can be situated remotely from the electromagnet or can be provided laterally with respect to the longitudinal axis. The elongate hole permits a controlled and guided movement of the pawl. The latching means can have a tooth which forms the restoring surface and the latching surface.

In aspects, the multi-part pawl can comprise at least two pawl parts, which can be arranged to be movable relative to one another and on one another. As a result, for example, the spring element can be arranged exclusively on the pawl itself. The armature or the armature rod can be kept free of the spring element.

In aspects, the at least two pawl parts can be mounted rotatably on one another. This serves for a buckling movement of the latching means in itself and leads to a saving on installation space, in combination with a leg spring.

In aspects, one of the pawl parts can have or form a pawl part stop for another of the pawl parts. Firstly, the pawl part stop can define an end position between the respective pawl parts—still further, the two pawl parts are then not adjustable with respect to one another. As a result, an adjustment travel of a pawl part can be restricted. Secondly, the pawl part stop can function as a driver and, when the one pawl part is adjusted, can carry along the other pawl part. As a result, the latching means can be electromagnetically caused to move out of its latching position. As a result of the pawl part stop, the pawl part without the pawl part stop can therefore be restricted in adjustment travel in one of its adjustment directions and can be movable in the opposite adjustment direction relative to the pawl part with pawl part stop and can be positively coupled to the pawl part with pawl part stop. The positive coupling can be affected by means of the spring element.

According to one embodiment of the locking arrangement, the armature rod can comprise a guide element which can be fixedly connected to the armature rod and can have a bearing point, for example a bearing mandrel, for the latching means. In aspects having the guide element, the remaining armature rod can have a smaller diameter and be slenderer. This is because the adjustment of the latching means into its release position can then be made possible by the adjustment of the guide element. The latching means can be mounted at the bearing point; the bearing mandrel can engage in the elongate hole. The bearing mandrel can be oriented perpendicular to the longitudinal axis.

In aspects, the spring element can be a leg spring which is supported at one end on a pawl part of the multi-part pawl and at the other end on another pawl part of the multi-part pawl. The leg spring advantageously serves to pretension both pawl parts against one another, for example, in the direction of the pawl part stop. The pawl parts can buckle with respect to one another and return to the pretensioned initial position because of the spring.

In aspects, the armature can be fixedly connected to the armature rod or the armature rod body. This reduces the number of components and leads to a uniform movement of armature and armature rod/armature rod body. This avoids movability, requiring installation space, between armature and armature rod/armature rod body.

In aspects, the armature rod can comprise an armature rod body and the guide housing or the guide element. As a result, it is possible to form an assembly which enables structural advantages and cost reductions.

In aspects, the guide element can be arranged on one end of the armature rod body. This reduces the required installation space.

In aspects, the latter can be designed such that the latching means can be brought into the release position counter to the spring force of the spring element and the subsequent movement of the latching means into the latching position can take place while the armature is stationary. Moreover, in the meantime, the armature can remain in a stable position and/or the coil can be unenergized in the meantime. Advantageously, therefore, neither energization is necessary nor does an air gap have to be produced at the armature. The locking arrangement can reliably prevent the unintentional rolling away of a motor vehicle. This can be brought about, for example, by means of the spring element and the relatively movable mounting of pawl parts with respect to one another.

The rotatable component can be a toothed wheel or a shaft. As a result, the locking arrangement can interact in a simple and installation-space-saving manner with a component which itself can also belong to another arrangement, for example to an electric motor. The rotatable component can be drivable by an electric motor. The engagements can be arranged on the outer circumferential side of the rotatable component; this location may also be true of the teeth. This exposes them in a simple manner to latching by the latching means, which can engage from the outside. The axis of the rotatable component can be its axis of rotation. The rotatable component can be rotatable relative to the electromagnet. The engagements can be arranged equidistantly with respect to one another and/or cover the entire circumference. The rotatable component can be formed rotationally symmetrically with respect to the axis. As a result, the position of the rotatable component with respect to the latching means basically has no effect on the latching position. The directions of rotation can be opposed.

The connection between armature rod and latching means can be a positive coupling.

The armature and the armature rod can be oriented concentrically with respect to one another. The armature and the armature rod can be movable in the longitudinal direction in the armature space. The armature can have an axial bore which receives the armature rod. The armature rod can project from the armature on one side, or on both sides.

The disclosure also comprises a method for operating a locking arrangement according to the disclosure, comprising the following steps:
providing a locking arrangement according to the disclosure,
adjusting the locking arrangement into its parking position, wherein the latching means engages in one of the engagements in order to prevent rotation in the first direction of rotation of the rotatable component,
carrying out readjustment, comprising the following sub-steps:
   while the coil is unenergized, rotating the rotatable component in the second direction of rotation and, as a result, bringing the latching means into the release position counter to the spring force of the spring element,
   while the coil is unenergized, re-engaging the latching means in one of the engagements to prevent rotation in the first direction of rotation of the rotatable component.

In the parking position, the locking arrangement is suitable for preventing an undesired rolling away of a motor vehicle. The advantages already described above in relation to the locking arrangement also arise analogously for the operating method, to which reference is hereby made. The readjustment can take place entirely when the coil is not energized or the armature is not adjusted. The method steps can be performed in the sequence specified.

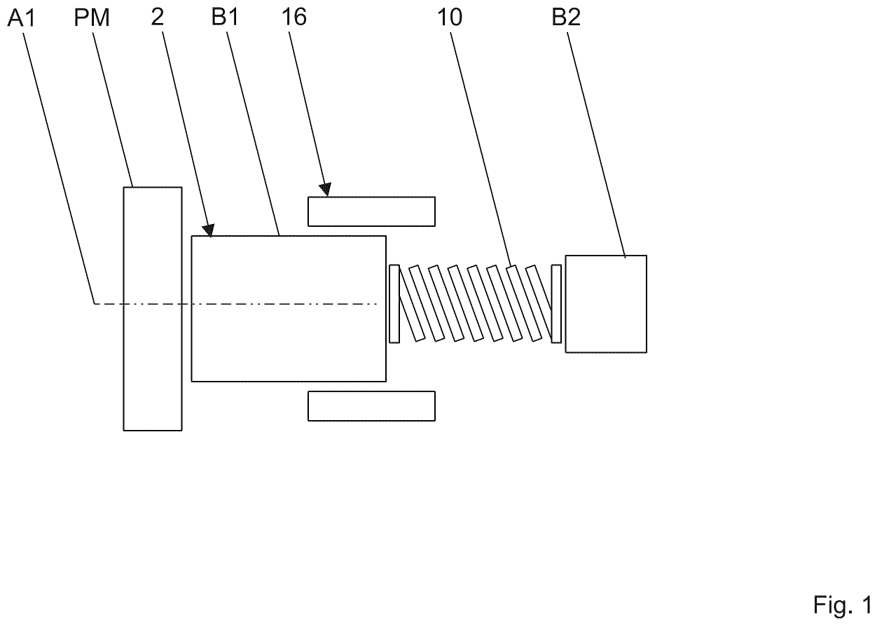

FIG. 1 schematically shows an electromagnet 2 which can be used, for example, for a locking arrangement 100, 200, 300, 400. The electromagnet 2 is passed through by an axis A1 or longitudinal axis. It comprises a selectively energizable coil 16 for adjusting an armature. The electromagnet 2 furthermore comprises a spring element 10, which is supported at both ends. At one end, it is supported on a first bearing base B1. The bearing base B1 can be realized by a component of the electromagnet 2. At the other end, it is supported on a second bearing base B2. The bearing base B2 can be realized by a component of the electromagnet 2 or by a component separate from the electromagnet. The spring element 10 is compressible between the bearing bases B1, B2. The bearing bases B1, B2 are mounted movably relative to one another.

The first bearing base B1 can be realized, for example, by an armature of the electromagnet 2 or the armature rod of the electromagnet 2. The first bearing base B1, which is fixed in a stable and permanent-magnetic end position on a permanent magnet PM, is shown in the present case. The second bearing base B2 can be realized, for example, by the armature rod of the electromagnet 2 or a component guided on the armature rod, for example a guide housing 252.

The spring element 10 makes it possible for the second bearing base B2 to be movable relative to the armature and/or the armature rod while the coil 16 is unenergized and/or during the stable and permanent-magnetic end position of the armature.

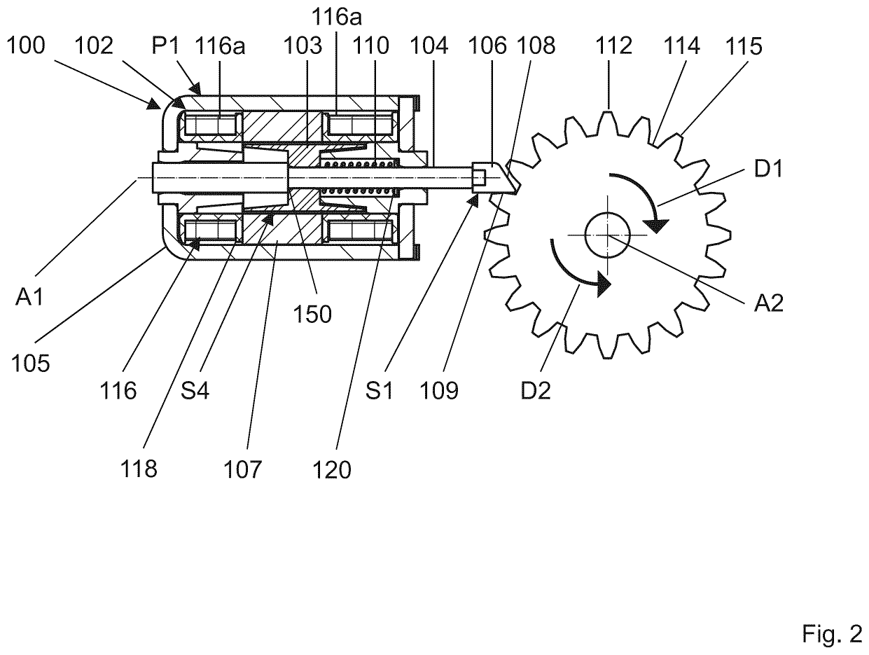

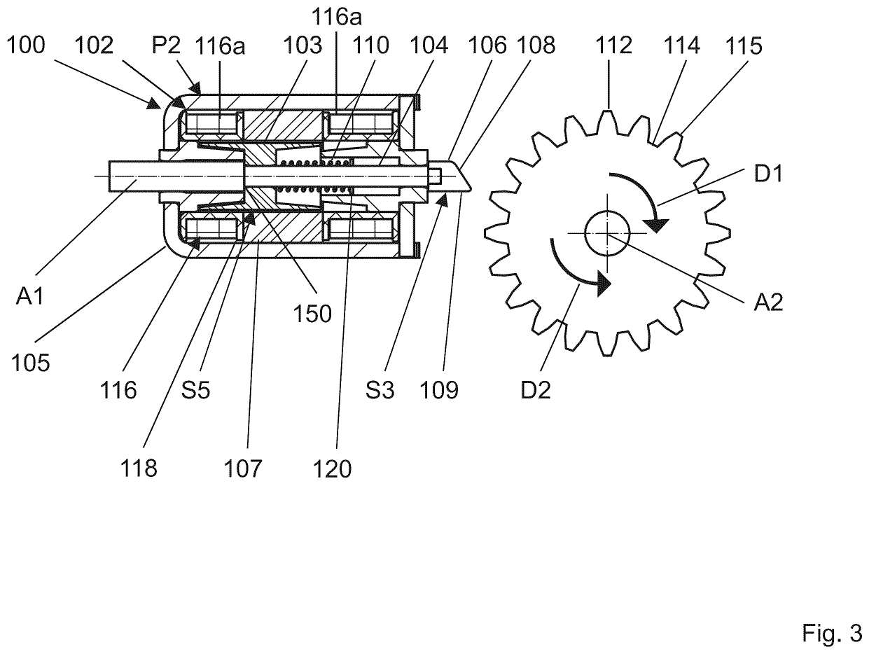

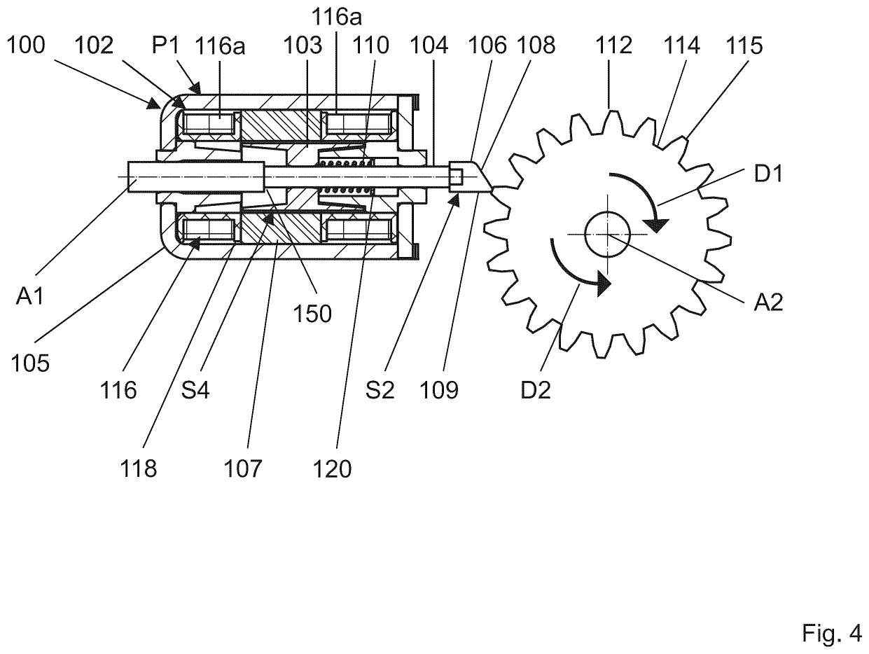

FIGS. 2 to 4 show a locking arrangement 100 of a first embodiment in each case in a longitudinal sectional view. The locking arrangement 100 is passed through by an axis A1. FIG. 2 shows a state in which the locking arrangement 100 is in its parking position P1, an electromagnet 102 or its armature 103 is in an extension position S4 and a latching means 106 is in its latching position S1. FIG. 3 shows a state in which the locking arrangement 100 is in its driving position P2, the electromagnet 102 or its armature 103 is in a retraction position S5 and the latching means 106 is in its neutral position S3. FIG. 4 is similar to FIG. 2 and shows a state in which the locking arrangement 100 is in its parking position P1, the electromagnet 102 or its armature 103 is in an extension position S4 and a latching means 106 is in its release position S2.

The locking arrangement 100 comprises the electromagnet 102. In the present case, said electromagnet is configured as a bistable lifting magnet. The electromagnet 102 comprises a housing 105 and an energizable coil 116, wound on a coil body 118. The coil 116 comprises two coil packets 116a which are spaced apart in the direction of the axis A1 and which enclose a ferromagnetic ring element 107 with one another. The electromagnet 102 further comprises the armature 103 and an armature rod 104, which protrudes from the housing 105 at one end. The armature 103 is adjustable by means of energization of the coil 116. The armature 103 and the armature rod 104 are oriented concentrically with respect to one another and are movable in an armature space in the direction of the axis A1 or in the longitudinal direction. The armature 103 has an axial bore which receives the armature rod 104.

The armature 103 is mounted movably relative to the armature rod 104 and is mounted on the armature rod 104 and/or on the coil body 118. The armature 103 can nevertheless adjust the armature rod 104 to produce the latching position S1. The armature rod 104 forms an armature stop 150, which is configured as an outer circumferential step or diameter step. With the armature stop 150, said armature rod can strike against the armature 103. As a result of the armature stop 150, the armature rod 104 can be restricted in adjustment travel in one of its adjustment directions (along the axis A1 in the direction of a rotatable component 112) and can be movable in the opposite adjustment direction (spaced apart from the rotatable component 112 along the axis A1) relative to the armature 103 and can be positively coupled to the armature 103. Specifically, if the armature 103 is to be adjusted electromagnetically from its extension position S4 shown in FIG. 2 into its retraction position S5 shown in FIG. 3, it carries along the armature rod 104 in its adjustment direction via the armature stop 150 owing to the positive coupling.

The locking arrangement 100 moreover comprises the rotatable component 112, which in the present case is illustrated as a toothed wheel. It is rotatable about an axis A2 in a first direction of rotation D1 and in an opposite second direction of rotation D2. The rotatable component 112 is rotatable relative to the electromagnet 102 and is formed rotationally symmetrically with respect to the axis A2. The rotatable component 112 comprises outer-circumferential-side engagements 114 and teeth 115, which are each arranged equidistantly with respect to one another and cover the entire circumference.

The locking arrangement 100 furthermore comprises the latching means 106. The latching means 106 is designed as a latching wedge and is fixedly connected to the armature rod 104 on its rod end facing the rotatable component 112. The latching means 106 comprises a restoring surface 108 and a latching surface 109. The two surfaces 108, 109 are formed on the two wedge sides and are arranged on opposite sides of the latching means 106. In the latching position S1, the latching means 106 engages in an engagement 114.

The restoring surface 108 is designed in such a way that, during rotation of the rotatable component 112 in the second direction of rotation D2, said component 112 acts with an engagement 114 or tooth on the restoring surface 108 in order to bring the latching means 106 into the release position S2 counter to the force of a spring element 110. The action of the rotatable component 112 on the restoring surface 108 upon rotation in the second direction of rotation D2 leads to the latching means 106 and the armature rod 104 being adjusted in the direction of the axis A1. The armature rod 104 is thus pushed into the housing 105.

The latching surface 109 is formed in such a way that, when the rotatable component 112 rotates in the first direction of rotation D1, this component 112 acts with an engagement 114 or tooth on the latching surface 109 and is prevented from rotating in this first direction of rotation D1.

The locking arrangement 100 moreover comprises a spring element 110, which in the present case is embodied as a helical compression spring. The spring element 110 is supported at one end on the armature 103 and at the other end on the armature rod 104 or on a support part 120 fixedly connected to the armature rod 104. The spring element 110 pretensions the latching means 106 into its latching position S1 and allows the latching means 106 to be restored into its release position S2 counter to the spring force of the spring element 110. The spring force of the spring element 110 is less than a permanent-magnetic holding force of the armature 103.

The locking arrangement 100 shown is adjustable between the parking position P1 and the driving position P2 by means of adjustment of the armature 103. In the parking position P1 (FIGS. 2 and 4), a motor vehicle is parked and prevented from rolling away, since the latching means 106 engages in the rotatable component 112 to prevent rotation (prevents rotation in the first direction of rotation D1). In the driving position P2 (FIG. 3), the motor vehicle can drive since the latching means 106 is spaced apart from the rotatable component 112 on account of corresponding adjustment of the armature 103.

The armature 103 shown is adjustable between the extension position S4 and the retraction position S5 by energizing of the coil 116. In the extension position S4 (FIGS. 2 and 4), the armature 103 is held stably and permanent-magnetically. The parking position P1 is provided because, in the extension position S4, the position of the armature 103 on the armature stop 150 allows the latching means 106 to engage in an engagement 114 in a spring-pretensioned manner. By contrast, in the retraction position S5 (FIG. 3), the armature 103 is held stably and permanent-magnetically in the second position of the bistable solenoid. The driving position P2 is provided because, in the retraction position S5, the armature 103 has adjusted the armature rod 104 via the armature stop 150 in such a way that the latching means 106 passes out of engagement on the engagement 114—the rotatable component 112 can rotate freely.

The latching means 106 shown is adjustable between the latching position S1, the release position S2 and the neutral position S3. In the latching position S1 (FIG. 2), it engages in one of the engagements 114 to prevent rotation of the rotatable component 112 in the first direction of rotation D1. Rotation of the rotatable component 112 in the second direction of rotation D2 leads to the release position S2 (FIG. 4). In the release position S2, which takes place during the parking position P1 of the locking arrangement 100 and also during the extension position S4 of the armature 103, if the latching means 106 comes out of engagement with the corresponding engagement 114 in order to release rotation in the second direction of rotation D2 of the rotatable component 112—readjustment can take place. In the neutral position S3 (FIG. 3), the latching means 106 is spaced apart from the rotatable component 112 owing to the adjustment of the armature into the retraction position S5.

The locking arrangement 100 is therefore designed in such a way that the latching means 106 can be brought into the release position S2 counter to the spring force of the spring element 110 and the subsequent movement of the latching means 106 into the latching position S1 can take place while the armature 103 is stationary. Meanwhile, the armature remains in a stable position when the coil 116 is not energized.

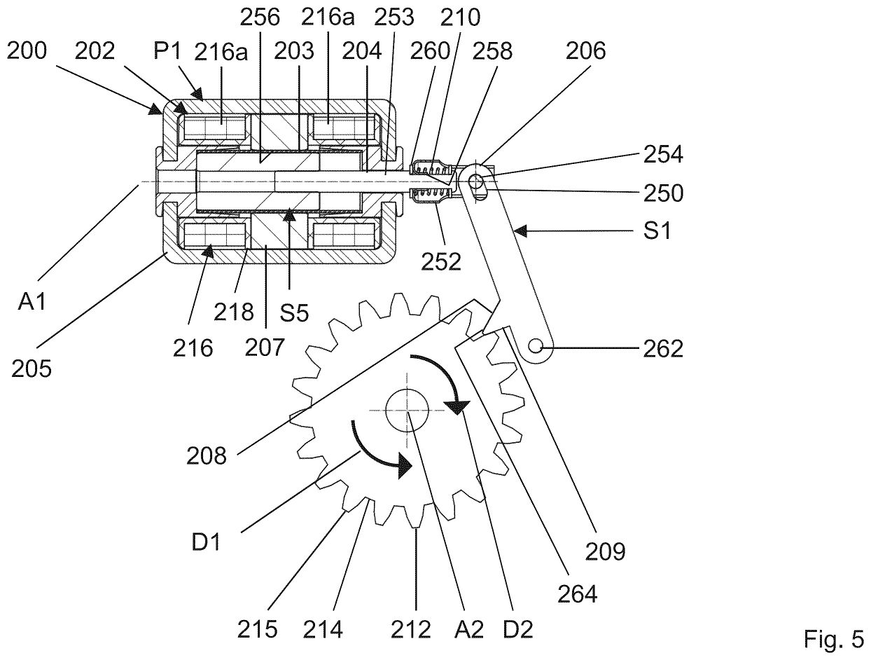

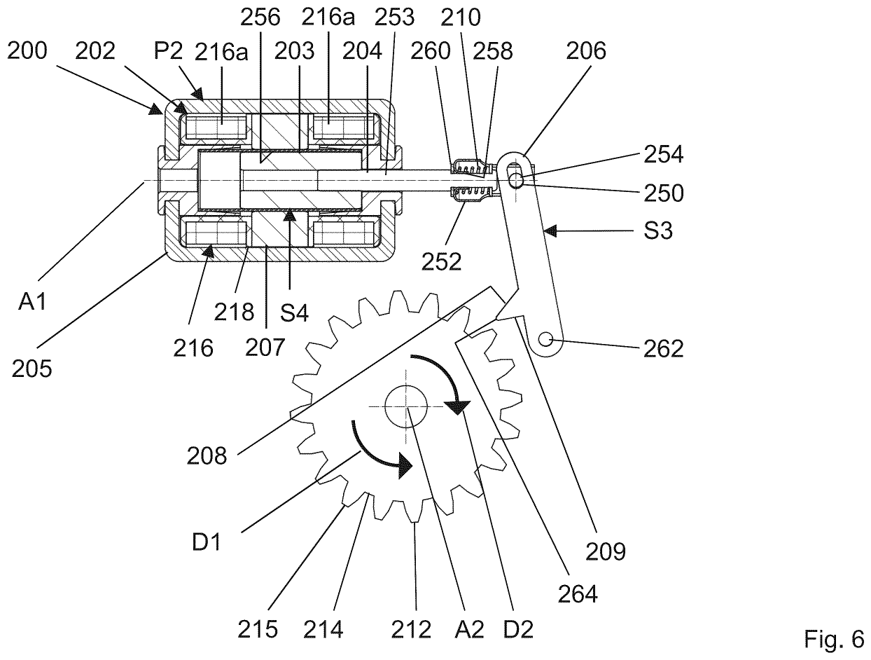

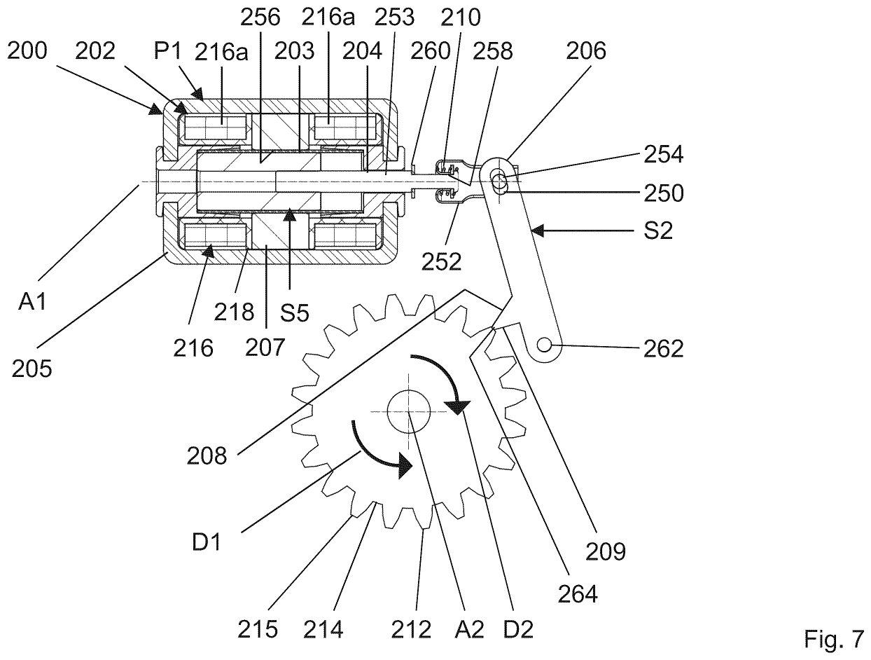

FIGS. 5 to 7 show a locking arrangement 200 of a second embodiment in each case in a longitudinal sectional view. The locking arrangement 200 is passed through by an axis A1. FIG. 5 shows a state in which the locking arrangement 200 is in its parking position P1, an electromagnet 202 or its armature 203 is in a retraction position S5 and a latching means 206 is in its latching position S1. FIG. 6 shows a state in which the locking arrangement 200 is in its driving position P2, the electromagnet 202 or its armature 203 is in an extension position S4 and the latching means 206 is in its neutral position S3. FIG. 7 is like FIG. 5 and shows a state in which the locking arrangement 200 is in its parking position P1, the electromagnet 202 or its armature 203 is in the retraction position S5 and the latching means 206 is in its release position S2.

The locking arrangement 200 comprises the electromagnet 202. In the present case, said electromagnet is configured as a bistable lifting magnet. The electromagnet 202 comprises a housing 205 and an energizable coil 216, wound on a coil body 218. The coil 216 comprises two coil packets 216a which are spaced apart in the direction of the axis A1 and which enclose a ferromagnetic ring element 207 with one another. The electromagnet 202 further comprises the armature 203 and an armature rod 204, which protrudes from the housing 205 at one end. The armature 203 is adjustable by means of energization of the coil 216. The armature 203 and the armature rod 204 are oriented concentrically with respect to one another and are movable in an armature space in the direction of the axis A1 or in the longitudinal direction. The armature 203 has an axial bore which receives the armature rod 204.

The armature 203 and the armature rod 204 are fixedly connected to one another. The armature 203 is mounted, for example, on the coil body 218 or an armature tube 256. The armature 203 can adjust the armature rod 204 to produce the latching position S1. The armature rod 204 comprises a guide housing 252 and an armature rod body 253. The guide housing 252 is arranged on one end of the armature rod body 253 and is guided on the armature rod body 253 to be movable in the longitudinal direction thereof. The guide housing 252 has a bearing point in the form of a bearing mandrel 254 for the latching means 206. The bearing mandrel 254 can be aligned perpendicular to the axis A1 or longitudinal axis. The inner circumferential side of the guide housing 252 has a support surface 258 for guiding on the armature rod body 253, wherein the support surface 258 is formed by a wall of the guide housing 252 which is turned over inwards radially.

The armature rod forms a guide housing stop 260. The guide housing stop 260 can restrict an adjustment travel of the guide housing 252.

As a result of the guide housing stop 260, the guide housing 252 can therefore be restricted in adjustment travel in one of its adjustment directions (along the axis A1 in the direction of the electromagnet 202) and can be movable in the opposite adjustment direction (spaced apart from the electromagnet 202 along the axis A1) relative to the armature rod body and can be positively coupled to the armature rod body 253. Specifically, if the armature 203 is to be adjusted electromagnetically from its retraction position S5 shown in FIG. 5 into its extension position S4 shown in FIG. 6, it carries along the guide housing 252 in its adjustment direction via the guide housing stop 260 owing to the positive coupling.

The locking arrangement 200 moreover comprises the rotatable component 212, which in the present case is illustrated as a toothed wheel. It is rotatable about an axis A2 in a first direction of rotation D1 and in an opposite second direction of rotation D2. The rotatable component 212 is rotatable relative to the electromagnet 202 and is formed rotationally symmetrically with respect to the axis A2. The rotatable component 212 comprises outer-circumferential-side engagements 214 and teeth 215, which are each arranged equidistantly with respect to one another and cover the entire circumference.

The locking arrangement 200 furthermore comprises the latching means 206. The latching means 206 is designed as a one-part pawl and is mounted movably relative to the armature rod 204. The latching means 206 has an elongate hole 250, in which the bearing mandrel 254 engages. The latching means 206 is thus mounted on the guide housing 252 to be rotatable about the bearing mandrel 254 and so as to be displaceable along the elongate hole 250. At the other end, the latching means 206 is mounted on a rotary bearing 262. The latching means 206 has a tooth 264, a restoring surface 208 and a latching surface 209. The two surfaces 208, 209 are formed on the tooth 264 of the latching means 206 and are arranged on opposite sides of the tooth 264. In the latching position S1, the latching means 206 engages in an engagement 214.

The restoring surface 208 is designed in such a way that, during a rotation of the rotatable component 212 in the second direction of rotation D2, said component 212 acts with an engagement 214 or tooth 215 on the restoring surface 208 in order to bring the latching means 206 into the release position S2 counter to the force of a spring element 210. The action of the rotatable component 212 on the restoring surface 208 upon rotation in the second direction of rotation D2 leads to the latching means 206, but not the armature rod body 253 and not the armature 203, being adjusted in the direction of the axis A1.

The latching surface 209 is formed in such a way that, when the rotatable component 212 rotates in the first direction of rotation D1, this component 212 acts with an engagement 214 or tooth 215 on the latching surface 209 and is prevented from rotating in this first direction of rotation D1.

The armature rod 204 is kinematically coupled to the latching means 206 in such a way that a linear adjustment of the armature rod 204 leads to rotation of the latching means 206.

The locking arrangement 200 moreover comprises a spring element 210, which in the present case is embodied as a helical compression spring. The spring element 210 is supported at one end on the guide housing 252 and at the other end on the armature rod body 253. The spring element 210 pretensions the latching means 206 into its latching position S1 and allows the latching means 206 to be restored into its release position S2 counter to the spring force of the spring element 210. The spring element 210 is arranged on the outer circumferential side with respect to the armature rod body 253 and within the guide housing 252.

The locking arrangement 200 shown is adjustable between the parking position P1 and the driving position P2 by means of adjustment of the armature 203. In the parking position P1 (FIGS. 5 and 7), a motor vehicle is parked and prevented from rolling away, since the latching means 206 engages in the rotatable component 212 to prevent rotation (prevents rotation in the first direction of rotation D1). In the driving position P2 (FIG. 6), the motor vehicle can drive since the latching means 206 is spaced apart from the rotatable component 212 on account of corresponding adjustment of the armature 203.

The armature 203 shown is adjustable between the extension position S4 and the retraction position S5 by energizing of the coil 216. In the retraction position S5 (FIGS. 5 and 7), the armature 203 is held stably and permanent-magnetically. The parking position P1 is provided because, in the retraction position S5, the positions of the armature 203 and the armature rod 204 allow the latching means 206 to engage in an engagement 214 in a spring-pretensioned manner. By contrast, in the extension position S4 (FIG. 6), the armature 203 is held stably and permanent-magnetically in the second position of the bistable solenoid. The driving position P2 is provided because, in the extension position S4, the armature 203 has adjusted the guide housing 252 in such a way that the latching means 206 passes out of engagement on the engagement 214—the rotatable component 212 can rotate freely.

The latching means 206 shown is adjustable between the latching position S1, the release position S2 and the neutral position S3. In the latching position S1 (FIG. 5), it engages in one of the engagements 214 to prevent rotation of the rotatable component 212 in the first direction of rotation D1. Rotation of the rotatable component 212 in the second direction of rotation D2 leads to the release position S2 (FIG. 7). In the release position S2, which takes place during the parking position P1 of the locking arrangement 200 and also during the retraction position S5 of the armature 203, if the latching means 206 comes out of engagement with the corresponding engagement 214 in order to release rotation in the second direction of rotation D2 of the rotatable component 212—readjustment can take place. In the neutral position S3 (FIG. 7), the latching means 206 is spaced apart from the rotatable component 212 owing to the adjustment of the armature 203 into the extension position S4.

The locking arrangement 200 is therefore designed in such a way that the latching means 206 can be brought into the release position S2 counter to the spring force of the spring element 210 and the subsequent movement of the latching means 206 into the latching position S1 can take place while the armature 203 is stationary. Meanwhile, the armature 203 remains in a stable position when the coil 216 is not energized.

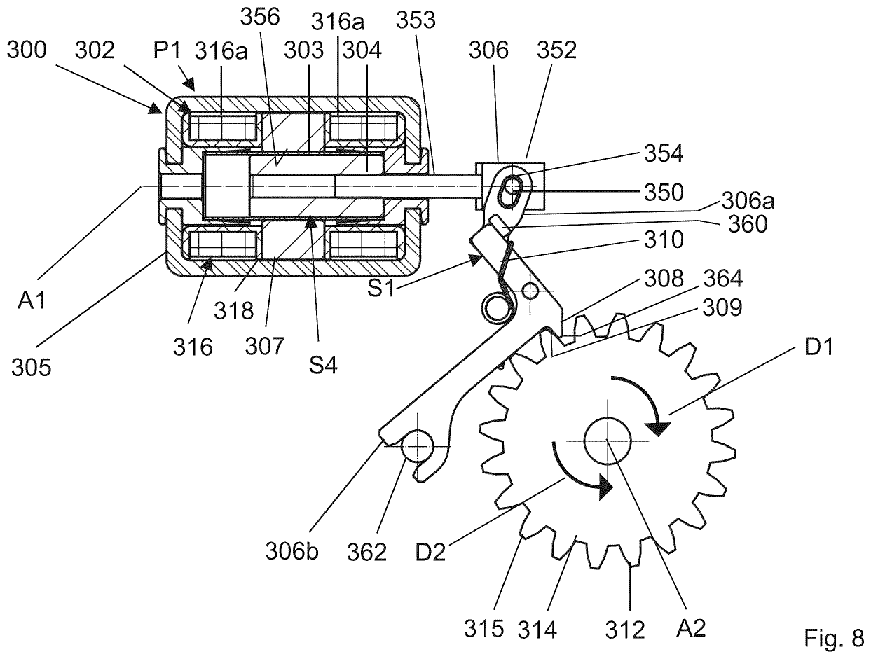

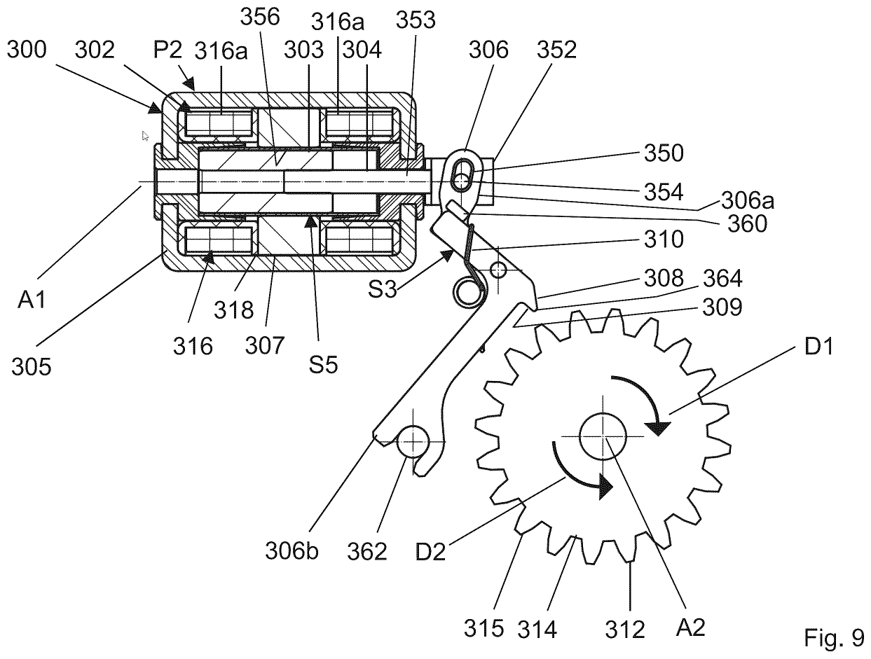

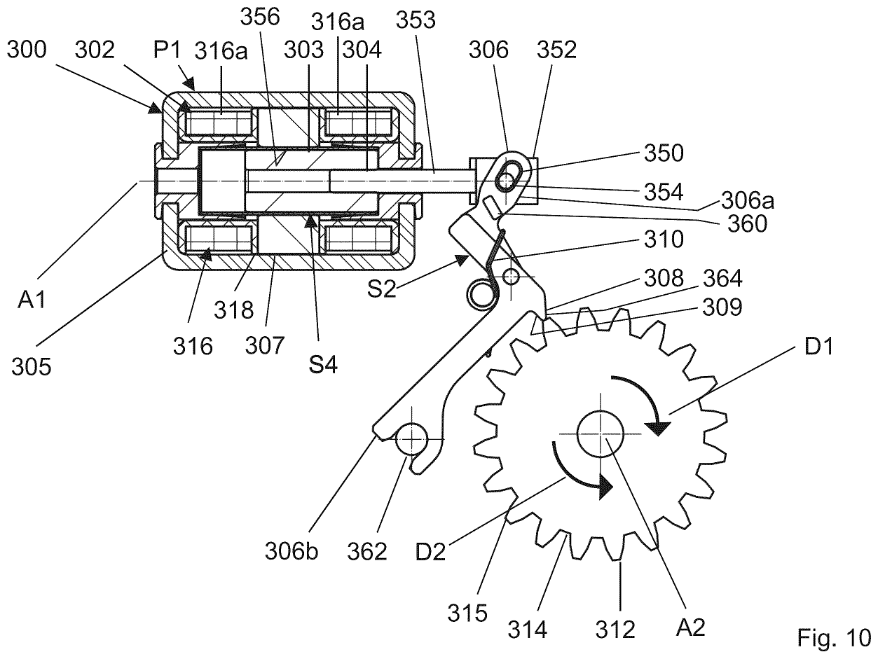

FIGS. 8 to 10 show a locking arrangement 300 of a third embodiment in each case in a longitudinal sectional view. The locking arrangement 300 is passed through by an axis A1. FIG. 8 shows a state in which the locking arrangement 300 is in its parking position P1, an electromagnet 302 or its armature 303 is in an extension position S4 and a latching means 306 is in its latching position S1. FIG. 9 shows a state in which the locking arrangement 300 is in its driving position P2, the electromagnet 302 or its armature 303 is in a retraction position S5 and the latching means 306 is in its neutral position S3. FIG. 10 is similar to FIG. 8 and shows a state in which the locking arrangement 300 is in its parking position P1, the electromagnet 302 or its armature 303 is in an extension position S4 and a latching means 306 is in its release position S2.

The locking arrangement 300 comprises the electromagnet 302. In the present case, said electromagnet is configured as a bistable lifting magnet. The electromagnet 302 comprises a housing 305 and an energizable coil 316, wound on a coil body 318.

The coil 316 comprises two coil packets 316a which are spaced apart in the direction of the axis A1 and which enclose a ferromagnetic ring element 307 with one another. The electromagnet 302 further comprises the armature 303 and an armature rod 304, which protrudes from the housing 305 at one end. The armature 303 is adjustable by means of energization of the coil 316. The armature 303 and the armature rod 304 are oriented concentrically with respect to one another and are movable in an armature space in the direction of the axis A1 or in the longitudinal direction. The armature 303 has an axial bore which receives the armature rod 304.

The armature 303 and the armature rod 304 are fixedly connected to one another. The armature 303 is mounted, for example, on the coil body 318 or an armature tube 356. The armature 303 can adjust the armature rod 304 to produce the latching position S1. The armature rod 304 comprises a guide element 352 and an armature rod body 353. The guide element 352 is arranged at one end of the armature rod body 353 and is fixedly connected to the armature rod body 353. The guide element 352 has a bearing point in the form of a bearing mandrel 354 for the latching means 306. The bearing mandrel 354 can be aligned perpendicular to the axis A1 or longitudinal axis.

The locking arrangement 300 moreover comprises the rotatable component 312, which in the present case is illustrated as a toothed wheel. It is rotatable about an axis A2 in a first direction of rotation D1 and in an opposite second direction of rotation D2. The rotatable component 312 is rotatable relative to the electromagnet 302 and is formed rotationally symmetrically with respect to the axis A2. The rotatable component 312 comprises outer-circumferential-side engagements 314 and teeth 315, which are each arranged equidistantly with respect to one another and cover the entire circumference.

The locking arrangement 300 furthermore comprises the latching means 306. The latching means 306 is designed as a multi-part pawl and is mounted movably relative to the armature rod 304. The multi-part pawl comprises two pawl parts 306a, 306b, which are arranged to be movable relative to one another and on one another about a pivot point 306c. On one pawl part 306a, the latching means 306 has an elongate hole 350, in which the bearing mandrel 354 engages. The latching means 306 is thus mounted on the guide element 352 to be rotatable about the bearing mandrel 354 and so as to be displaceable along the elongate hole 350. At the other end, the latching means 306 is mounted on a rotary bearing 362. The latching means 306 has a tooth 364, a restoring surface 308 and a latching surface 309. The two surfaces 308, 309 are formed on the tooth 364 of the latching means 306 and are arranged on opposite sides of the tooth 364.

In the latching position S1, the latching means 306 engages in an engagement 314. The restoring surface 308 is designed in such a way that, during a rotation of the rotatable component 312 in the second direction of rotation D2, said component 312 acts with an engagement 314 or tooth 315 on the restoring surface 308 in order to bring the latching means 306 into the release position S2 counter to the force of a spring element 310. The action of the rotatable component 312 on the restoring surface 308 upon rotation in the second direction of rotation D2 leads to the two pawl parts 306a, 306b of the latching means 306 rotating relative to one another about the pivot point 306c, but not to the armature rod 304 and also not to the armature 303 being adjusted in the direction of the axis A1.

The latching surface 309 is formed in such a way that, when the rotatable component 312 rotates in the first direction of rotation D1, this component 312 acts with an engagement 314 or tooth 315 on the latching surface 309 and is prevented from rotating in this first direction of rotation D1.

One of the pawl parts 306a, 306b has a pawl part stop 360 for the other of the pawl parts 306a, 306b. The pawl part stop 360 can restrict an adjustment travel of the other of the pawl parts 306a, 306b.

As a result of the pawl part stop 360, the pawl part 306b without pawl part stop 360 can therefore be restricted in adjustment travel in one of its adjustment directions (about the pivot point 306c with the spring force of a spring element 310) and can be movable in the opposite adjustment direction (about the pivot point 306c counter to the spring force of the spring element 310) relative to that of the armature rod 304 and the armature 303 and can be positively coupled to the pawl part 306a with pawl part stop 360. Specifically, if the armature 303 is to be adjusted electromagnetically from its extension position S4 shown in FIG. 6 into its retraction position S5 shown in FIG. 9, it carries along the two pawl parts 306a, 306b of the latching means 306 in its adjustment direction via the guide element 352 owing to the positive coupling.

The armature rod 304 is kinematically coupled to the latching means 306 in such a way that a linear adjustment of the armature rod 304 leads to rotation of the latching means 306.

The locking arrangement 300 moreover comprises the spring element 310, which in the present case is embodied as a leg spring. The spring element 310 is supported at one end on one of the pawl parts 306a, 306b and at the other end on the other of the pawl parts 306a, 306b. The spring element 310 pretensions the latching means 306 into its latching position S1 and allows the latching means 306 to be restored into its release position S2 counter to the spring force of the spring element 310. The spring element 310 also pretensions the pawl part 306b without pawl part stop 360 against the pawl part stop 360 on the other pawl part 306b.

The locking arrangement 300 shown is adjustable between the parking position P1 and the driving position P2 by means of adjustment of the armature 303. In the parking position P1 (FIGS. 8 and 10), a motor vehicle is parked and prevented from rolling away, since the latching means 306 engages in the rotatable component 312 to prevent rotation (prevents rotation in the first direction of rotation D1). In the driving position P2 (FIG. 9), the motor vehicle can drive since the latching means 306 is spaced apart from the rotatable component 312 on account of corresponding adjustment of the armature 303.

The armature 303 shown is adjustable between the extension position S4 and the retraction position S5 by energizing of the coil 316. In the extension position S4 (FIGS. 8 and 10), the armature 303 is held stably and permanent-magnetically. The parking position P1 is provided because, in the extension position S4, the positions of the armature 303 and the armature rod 304 allow the pawl parts 306a, 306b of the latching means 306 to lie against one another in a spring-pretensioned manner and the tooth 364 of the latching means 306 to engage in an engagement 314. By contrast, in the retraction position S5 (FIG. 9), the armature 303 is held stably and permanent-magnetically in the second position of the bistable solenoid. The driving position P2 is provided because, in the retraction position S5, the armature 303 has adjusted the guide element 352 in such a way that the latching means 306 passes out of engagement on the engagement 314—the rotatable component 312 can rotate freely.

The latching means 306 shown is adjustable between the latching position S1, the release position S2 and the neutral position S3. In the latching position S1 (FIG. 8), it engages in one of the engagements 314 to prevent rotation of the rotatable component 312 in the first direction of rotation D1. Rotation of the rotatable component 312 in the second direction of rotation D2 leads to the release position S2 (FIG. 10). In the release position S2, which takes place during the parking position P1 of the locking arrangement 300 and also during the extension position S4 of the armature 303, if the latching means 306 comes out of engagement with the corresponding engagement 314 in order to release rotation in the second direction of rotation D2 of the rotatable component 312—readjustment can take place. In the neutral position S3 (FIG. 9), the latching means 306 is spaced apart from the rotatable component 312 owing to the adjustment of the armature 303 into the retraction position S5.

The locking arrangement 300 is therefore designed in such a way that the latching means 306 can be brought into the release position S2 counter to the spring force of the spring element 310 and the subsequent movement of the latching means 306 into the latching position S1 can take place while the armature 303 is stationary. Meanwhile, the armature 303 remains in a stable position when the coil 316 is not energized.

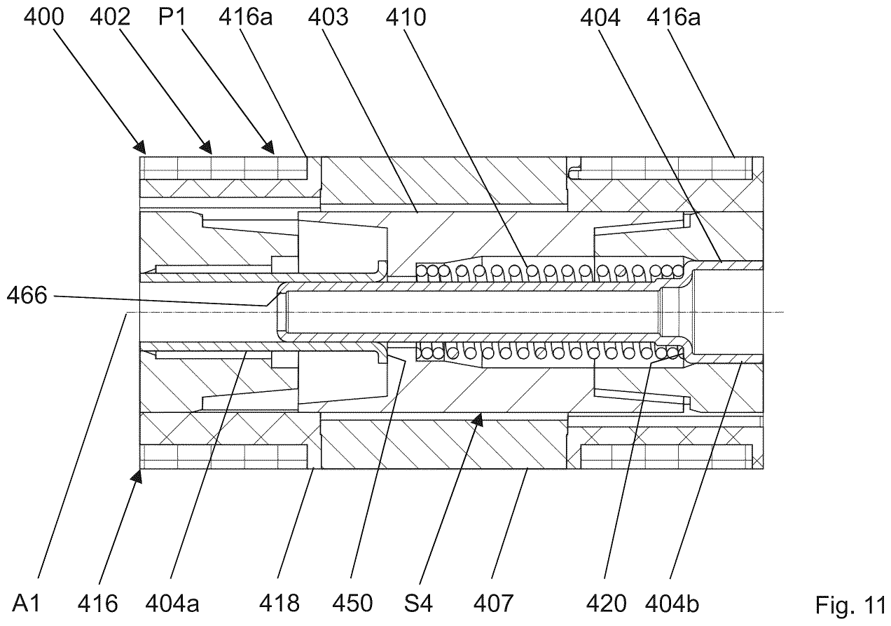

FIG. 11 shows a locking arrangement 400 of a fourth embodiment, which is like the locking arrangement 100 of the first embodiment, shown in FIG. 2, except for the description below. To avoid repetition, therefore, only the differences or details which have not yet been described are explained below. In the present case, instead of the 100th series for reference signs from the locking arrangement 100 of the first embodiment, a 400th series is used.

The locking arrangement 400 comprises a fully hollow armature rod 404 comprising a first armature rod part 404a and a second armature rod part 404b. The two armature rod parts 404a, 404b are plugged into one another and fixedly connected to one another. The interiors thereof are fluidically connected to one another, for example by means of an end-side hole 466 in one of the armature rod parts 404a, 404b. One of the armature rod parts 404a, 404b forms, on its end side, an outer circumferential flange which defines the armature stop 450. In the latching position S1 shown, but also in the neutral position S3, the armature stop 450 bears against the armature 403. The spring element 410 pulls the armature stop 450 towards the armature 403. The other armature rod part 404a, 404b of the armature rod parts 404a, 404b forms a diameter step which defines a direct support 421. The spring element 410 is supported on the support 421.

The present armature rod 404 replaces the support part by the direct support 421. The armature 403 is guided on the outer circumferential side of the coil body 418. As a result, a coaxial decoupling with respect to the armature rod 404 can be achieved.

List of reference signs

| | | | |
|---|---|---|---|
| 2 | Electromagnet | 300 | Locking arrangement |
| 10 | Spring element | 302 | Electromagnet |
| 16 | Coil | 303 | Armature |
| | | 304 | Armature rod |
| 100 | Locking arrangement | 305 | Housing |
| 102 | Electromagnet | 306 | Latching means |
| 103 | Armature | 306a | Pawl part |
| 104 | Armature rod | 306b | Pawl part |
| 105 | Housing | 306c | Pivot point |
| 106 | Latching means | 307 | Ring element |
| 107 | Ring element | 308 | Restoring surface |
| 108 | Restoring surface | 309 | Latching surface |
| 109 | Latching surface | 310 | Spring element |
| 110 | Spring element | 312 | Component |
| 112 | Component | 314 | Engagement |
| 114 | Engagement | 315 | Tooth |
| 115 | Tooth | 316 | Coil |
| 116 | Coil | 316a | Coil pack |
| 116a | Coil pack | 318 | Coil body |
| 118 | Coil body | 350 | Elongate hole |
| 120 | Support part | 352 | Guide element |
| 150 | Armature stop | 353 | Armature rod body |
| | | 354 | Bearing mandrel |
| 200 | Locking arrangement | 356 | Armature tube |
| 202 | Electromagnet | 360 | Pawl part stop |
| 203 | Armature | 362 | Rotary bearing |
| 204 | Armature rod | 364 | Tooth |
| 205 | Housing | | |
| 206 | Latching means | 400 | Locking arrangement |
| 207 | Ring element | 402 | Electromagnet |
| 208 | Restoring surface | 403 | Armature |
| 209 | Latching surface | 404 | Armature rod |
| 210 | Spring element | 404a | Armature rod part |
| 212 | Component | 404b | Armature rod part |
| 214 | Engagement | 410 | Spring element |
| 215 | Tooth | 421 | Support |
| 216 | Coil | 450 | Armature stop |
| 216a | Coil pack | 466 | Hole |
| 218 | Coil body | | |
| 250 | Elongate hole | A1 | Axis |
| 252 | Guide housing | A2 | Axis |
| 253 | Armature rod body | B1 | Bearing base |
| 254 | Bearing mandrel | B2 | Bearing base |
| 256 | Armature tube | D1 | First direction of rotation |
| 258 | Support surface | D2 | Second direction of rotation |
| 260 | Guide housing stop | P1 | Parking position |
| 262 | Rotary bearing | P2 | Driving position |
| 264 | Tooth | PM | Permanent magnet |
| | | S1 | Latching position |
| | | S2 | Release position |
| | | S3 | Neutral position |

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An electromagnet for a locking arrangement, the electromagnet comprising:
an armature, which can be fixed in at least one stable and permanent-magnetic end position;
an armature rod;
a selectively energizable coil for adjusting the armature; and
a spring element which is supported at one end on a first bearing base and at another end on a second bearing base, which is mounted movably relative to the first bearing base;
wherein the second bearing base is movable relative to the armature, the armature rod, or both the armature and the armature rod i) while the selectively energizable coil is not energized, ii) during a stable and permanent-magnetic end position of the armature, or iii) both i) and ii).

2. A locking arrangement comprising:
an electromagnet having an armature and an armature rod;
a component which is rotatable about an axis in a first direction of rotation and in an opposite second direction of rotation, wherein the component has circumferential engagements;
a latching means having a restoring surface, wherein the latching means is connected to the armature rod and is adjustable between a latching position and a release position, wherein in the latching position the latching means engages in one of the circumferential engagements for preventing rotation in the first direction of rotation of the component, wherein in the release position, the latching means comes out of engagement with the one of the circumferential engagements to release rotation in the opposite second direction of rotation of the component; and
a spring element that pretensions the latching means into the latching position and allows the latching means to be restored into the release position,
wherein the component can act on the restoring surface of the latching means during rotation in the opposite second direction of rotation in order to bring the latching means into the release position that is counter to a spring force of the spring element.

3. The locking arrangement according to claim 2, wherein the latching means is fixedly connected to the armature rod.

4. The locking arrangement according to claim 2, wherein the armature is movably mounted relative to the armature rod.

5. The locking arrangement according to claim 2, wherein the armature rod has or forms an armature stop that strikes against the armature.

6. The locking arrangement according to claim 2, wherein the spring element is a helical spring which is supported at one end on the armature and at another end directly on the armature rod.

7. The locking arrangement according to claim 2, wherein the spring element is a helical spring which is supported at one end on the armature and at another end on a supporting part fixedly connected to the armature rod.

8. The locking arrangement according to claim 2, wherein the latching means is a one-part pawl, is movably mounted at one end relative to the armature rod, or is a one-part pawl that is movably mounted at one end relative to the armature rod.

9. The locking arrangement according to claim 8, wherein the latching means is movably mounted at one end relative to the armature rod via an elongate hole and is mounted rotatably at another end.

10. The locking arrangement according to claim 8, wherein the armature rod comprises a guide housing which is movably guided on an armature rod body and has a bearing point for the latching means.

11. The locking arrangement according to claim 10, wherein the bearing point is a bearing mandrel.

12. The locking arrangement according to claim 2, wherein the latching means is a multi-part pawl, is movably mounted at one end movably relative to the armature rod, or is a multi-part pawl and is movably mounted at one end relative to the armature rod.

13. The locking arrangement according to claim 12, wherein the latching means is movably mounted at one end relative to the armature rod via an elongate hole and is mounted rotatably at another end.

14. The locking arrangement according to claim 12, wherein the armature rod comprises a guide element which is fixedly connected to the armature rod and has a bearing point for the latching means.

15. The locking arrangement according to claim 14, wherein the bearing point is a bearing mandrel.
